(19) United States
(12) Patent Application Publication
(10) Pub. No.: US 2019/0164039 A1
(43) Pub. Date: May 30, 2019

(54) GENERATING COMPOSITIONAL ARTIFACTS BASED ON SEED ARTIFACTS

(71) Applicant: International Business Machines Corporation, Armonk, NY (US)

(72) Inventors: Aditya Vempaty, Elmsford, NY (US); Richard B. Segal, Chappaqua, NY (US); Ashish Jagmohan, Irvington, NY (US); Richard T. Goodwin, Dobbs Ferry, NY (US); Flavio du Pin Calmon, Cambridge, MA (US)

(21) Appl. No.: 15/826,771

(22) Filed: Nov. 30, 2017

(51) Int. Cl. G06N 3/04; G06N 3/08

(52) U.S. Cl. CPC G06N 3/0427; G06N 3/08

(57) ABSTRACT

A compositional artifact may be identified, and a set of logical coordinates within a composition model may be determined for the compositional artifact. The set of logical coordinates may be determined based on the components of the compositional artifact. Tolerance parameters may be used in conjunction with the set of logical coordinates to calculate a logical distance, and other artifacts in the composition model whose logical coordinates fall within the logical distance may be displayed to a user.

### BACKGROUND

The present disclosure relates generally to generating computer models, and more particularly to using composition models to generate compositional artifacts based on seed artifacts.

Compositional artifacts, such as food flavorings, recipes, etc., have benefited from expert principles, such as flavor-pairing hypotheses and pscyho-hedonic models. Commercially generated artifacts (e.g., formulas generated by flavor-houses) tend to be too complex to be well-reasoned or predicted by a few heuristics or “rules of thumb.” Traditional methods (e.g., flavor-pairing and psycho-hedonic models) for generating artifacts cannot be used with anonymized data.

### SUMMARY

Embodiments of the present disclosure include a method, computer program product, and system for using learned models to generate compositional artifacts.

A first artifact is identified, and a first set of logical coordinates within the compositional model is determined for the first artifact. A tolerance parameter is identified, and a logical distance from the first artifact is calculated, based on the first set of logical coordinates and the tolerance parameter. A second artifact is identified, and the second artifact has a second set of logical coordinates within the logical distance from the first set of logical coordinates of the first artifact. A user is notified of the second artifact.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a high-level diagram of an example environment for using composition models to generate compositional artifacts based on seed artifacts, in which illustrative embodiments of the present disclosure may be implemented.

FIG. 2 illustrates an example representation of a spatial composition artifact model, in accordance with embodiments of the present disclosure.

FIG. 3 illustrates a block diagram of an example natural language processing system configured to analyze one or more textual artifacts, in accordance with embodiments of the present disclosure.

FIG. 4 illustrates a block diagram of an example high level architecture of a system for determining artifact compositions, in accordance with embodiments of the present disclosure.

FIG. 5 illustrates a block diagram of an example computing environment for generating composition models to generate compositional artifacts based on seed artifacts, in accordance with embodiments of the present disclosure.

FIG. 6 illustrates an example neural network 600 that may be specialized to process a set of components and/or relative compositions associated with a compositional artifact.

FIG. 7 illustrates a flowchart of a method for using a composition model to identify compositional artifacts based on seed artifacts, in accordance with embodiments of the present disclosure.

FIG. 8 illustrates a flowchart of a method for using a composition model to generate and compositional artifacts and adjust logical coordinate determinations, in accordance with embodiments of the present disclosure.

FIG. 9 illustrates a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of generating computer models, and more particularly to using composition models to generate compositional artifacts based on seed artifacts. While the present disclosure is not necessarily limited to such applications, various aspects of the disclosure may be appreciated through a discussion of various examples using this context.

As discussed above, commercially generated compositional artifacts (e.g., products whose composition results in a desired effect, such as a formula for a food flavoring that results in a particular flavor or taste), and methods for generating them, are often complex. Therefore, strictly rule-based approaches may be inadequate for producing a desired compositional artifact. A data-driven approach, as contemplated in the present disclosure, provides for the ability to use anonymized data and generate compositional artifacts from seed artifacts. As such, the present disclosure provides for data-driven selection of artifact components, which may provide novel results when comparing seed artifacts to known compositional artifacts, or when generating new compositional artifacts based on seed artifacts.

Using historical data (e.g., textual formulae) and/or expert-generated artifacts (e.g., formulae created by professionals), compositional artifacts may be analyzed to learn their structure (e.g., component compounds and composition ratios). Artifact structures may be represented in a spatial model (e.g., 2D, 3D, etc.) by logical coordinates within the model space. Spatial modeling of the compositional artifacts, based on artifact structure, enables calculation of logical distances (e.g., Earthmover, Mahalanobis, Euclidian, etc.) between a seed artifact and a destination artifact (e.g., a compositional artifact at or within a specified logical distance from the seed artifact). Additionally, in embodiments, novel compositional artifacts may be generated by setting a logical distance from a seed artifact (e.g., a selected compositional artifact serving as “zero” logical distance) and exploring the spatial model to determine that a novel compositional artifact (e.g., a compositional artifact not found in the historical or expert-created data) may be generated at or within the specified logical distance from the seed artifact. For example, novel compositional artifacts may be based on components within the logical distance from the seed artifact. In embodiments, a user may specify certain parameters for calculating the logical distance. For example, a user may specify that a particular component must be identical between the seed artifact and the destination artifact, or that a particular component from the seed artifact must not be present in the destination artifact.

In embodiments, the user may specify that components and/or destination artifacts must be kept below a certain cost threshold. For example, when determining which components to consider, the present disclosure may cross-check current market rates and/or store prices for a formula's ingredients. In embodiments, the present disclosure may sort destination artifacts by user preference, demographic trends/preferences, cost, logical distance, etc.

The present disclosure may, in embodiments, be used to improve existing compositional artifacts (e.g., create near-identical recipes at lower cost, better taste, etc.), or to retain certain attributes across two or more compositional artifacts of different classes (e.g., retain the flavor/taste of a honey garlic chicken, but while making honey garlic potato chips). In embodiments, artifact components may be anonymized to provide the user with one or more “blind” variables when generating destination artifacts. Anonymized components may be represented by anonymized strings, hash values, arrays of values, etc.

In embodiments, users may provide feedback (e.g., too salty, too sweet, not spicy enough, etc.) that may be used to weight values when calculating logical coordinates, logical distances, or when generating destination artifacts.

As discussed above, aspects of the disclosure may relate to the field of generating computer models, and more particularly to using composition models to generate compositional artifacts based on seed artifacts. Accordingly, an understanding of the embodiments of the present disclosure may be aided by describing embodiments of natural language processing and composition analysis and the environments in which these systems may operate.

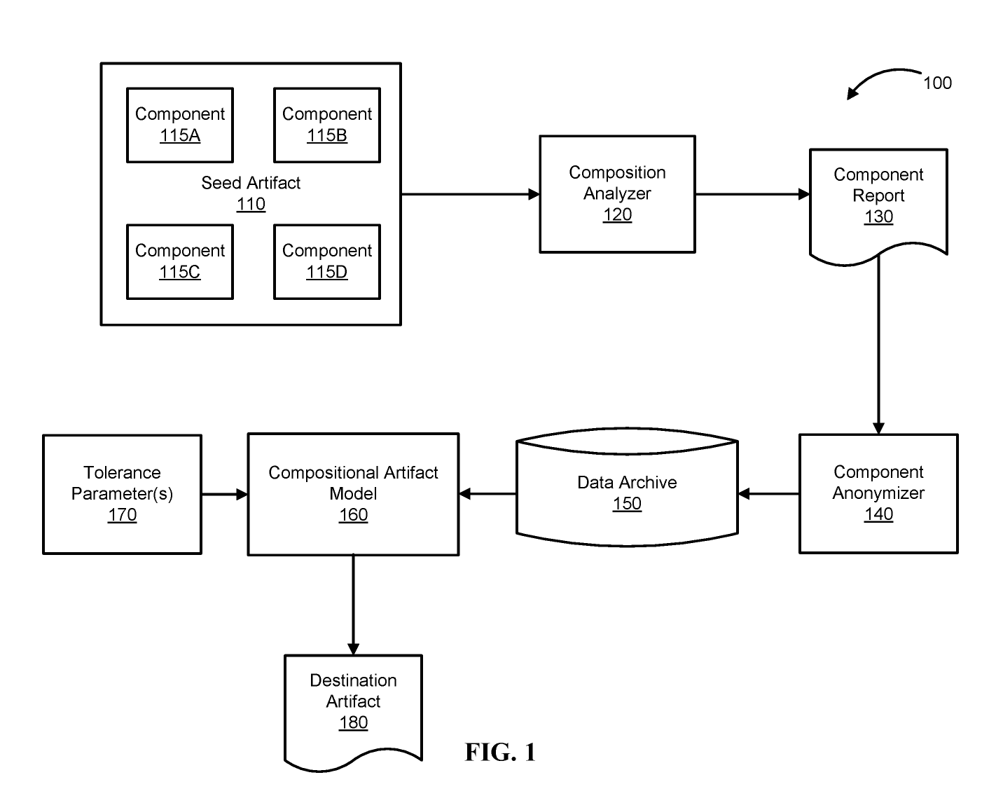

Turning now to the figures, FIG. 1 illustrates a high-level diagram of an example environment 100 for using composition models to generate compositional artifacts based on seed artifacts, in which illustrative embodiments of the present disclosure may be implemented.

In example environment 100, a seed artifact 110 may include components 115A, 115B, 115C, and 115D. In embodiments, seed artifact 110 may include fewer or more components than those illustrated here. In embodiments, seed artifact 110 may be a textual artifact (e.g., written formula) or a physical artifact (e.g., a physical sample of food). Components 115A-D may be characterized at various levels. For example, if the seed artifact is hash browns, components may be characterized as kitchen ingredients, such as 98% potatoes, 1.5% oil, and 0.5% salt. In embodiments, the components may be further characterized as chemical compounds or elements. For example, if the seed artifact is baking soda, the components may be characterized as 100% sodium bicarbonate, or 50% sodium and 50% bicarbonic acid. If the seed artifact is table salt, the components may be characterized as 50% sodium and 50% chloride. In embodiments, the composition percentage may be based on molar ratio, or it may be based on component weight, volume, etc. For example, if table salt were characterized by molar ratio, it would be characterized as 50% sodium and 50% chloride; however, if table salt were characterized by weight, it would be characterized as 40% sodium and 60% chloride.

Composition analyzer 120 may analyze the seed artifact to determine the seed artifact's components and composition ratios. In embodiments, composition analyzer 120 may include a computer system with a natural language processor for digesting the seed artifact's formula and identifying the ingredients, ingredient ratios, any chemical reactions from cooking/baking processes, etc., to arrive at a list of components in the finished product of a formula (e.g., seed artifact), as well as a ratio of the components.

In embodiments, composition analyzer 120 may include a chemical analyzer (e.g., mass spectrometer, chromatographer, etc.) for analyzing physical seed artifact samples. For example, mass spectrometry coupled with gas chromatography may be used to identify chemical compounds in a homogenized sample, as well as composition ratios of those compounds.

Component report 130 may include the output of composition analyzer 120 in a comprehensive report. In embodiments, component report 130 may be in electronic format. In embodiments, component report 130 may provide cascading tiers of component information. For example, in one tier, the components of bread may be listed as 30% water, 40% wheat flour, 5% salt, 5% yeast, 10% sugar, and 10% eggs. In a second tier, each of the aforementioned components may be further broken down into, for example, chemical compounds. For example, sugar may be listed, in the second tier, as 70% sucrose, 20% glucose, and 10% fructose. In embodiments, the components may be broken down further at each successive tier. Providing various tiers may assist, for example, in identifying which recipes do best with brand A of an ingredient versus brand B of an ingredient.

Component anonymizer 140 may be used to de-identify the components listed in component report 130. For example, sugar may be assigned a random identifier. Random identifiers may comprise letters, numbers, and/or symbols. Random identifiers may be arrays of numbers, hashes, etc. Anonymization may be recorded in a key table, or it may be performed in a standardized manner using algorithms, much like encryption techniques.

Data archive 150 may be used to store information related to compositional artifacts (e.g., food recipes, flavor profiles, food textures, component lists, anonymization tables or hash functions, etc.). In embodiments, data archive 150 may store the output of data anonymizer 140. In embodiments, data archive may also store component report 130. Data archive 150 may be located on a single device (e.g., as a hard drive on a server, laptop, desktop, mobile device, etc.), or it may exist, if at all, across a number of devices communicatively couple via a network connection (e.g., over the Internet, over an intranet, etc.).

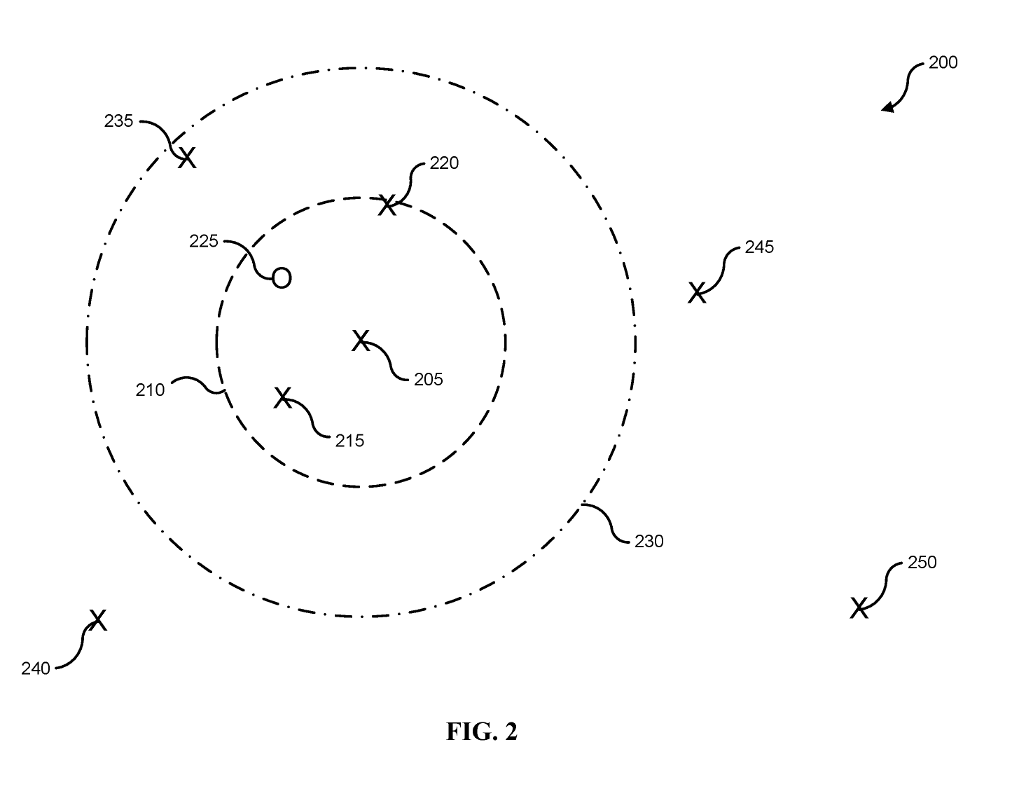

Compositional artifact model 160 may be a spatial model in which compositional artifacts may be represented by coordinates, as described herein. The coordinates of compositional artifacts may be based on the artifacts' components, relative compositions, and performance vectors (e.g., how the artifact tastes). A more detailed illustration of a spatial model is given in the description of FIG. 2.

Tolerance parameter(s) 170 may be used with compositional artifact model 160 to determine limits for a logical distance from a particular seed artifact represented in compositional artifact model 160. In embodiments, tolerance parameters may include the setting of a total logical distance (e.g., allowing a user to see all compositional artifacts within a particular distance of a seed artifact), and/or filtering of ingredients/components (e.g., selecting a particular component for inclusion/exclusion when identifying/generating destination artifacts). For example, a user may want to see all possible compositional artifacts within a logical distance of X from seed artifact Y. The user may further require that all possible compositional artifacts have a particular component, Z, but also require that none of them have component G. For example, a user may want to see all possible compositional artifacts, within a logical distance of 10 units, from a seed artifact of blueberry pie. The user may further utilize tolerance parameters 170 to filter out any compositional artifacts that do not have blueberries (e.g., all results must have blueberries), and to exclude all results with sugar (e.g., no results may have sugar). These exemplary tolerance parameters may be used in conjunction with compositional artifact model 160 to identify all compositional artifacts that have a similar (e.g., within 10 logical distance units) set of components and/or relative compositions and/or performance vectors (e.g., artifacts with similar ingredients and/or similar tastes/textures/etc.). In embodiments, compositional artifact model 160 may further generate novel compositional artifacts (e.g., new formulae/flavor profiles), so long as those novel compositional artifacts have logical coordinates that fall within the tolerance parameters defined by the user.

For example, if a seed artifact contains sugar, flour, and cow's milk, and every destination artifact within a specified logical distance contains a sugar-like substance, a flour-like substance, and cow's milk, a novel compositional artifact may be generated with a sugar-like substance, a flour-like substance, and sheep's milk, so long as the resulting novel compositional artifact still lies within the specified logical distance.

Destination artifact 180 may include one or more compositional artifacts that are within a specified logical distance of a seed artifact. In embodiments, destination artifact 180 may represent a list of compositional artifacts that are displayed to the user as the results of the methods described herein.

Turning now to FIG. 2, illustrated is an example representation of a spatial composition artifact model 200, in accordance with embodiments of the present disclosure. In spatial composition artifact model 200, the positions of various compositional artifacts 205, 215, 220, 225, 235, 240, 245, and 250 are shown. In embodiments, any number of compositional artifacts may be included. As described herein, the positions (e.g., logical coordinates) of compositional artifacts 205, 215, 220, 225, 235, 240, 245, and 250 may be calculated based on a set of components and/or relative compositions and/or performance vectors.

In this example, compositional artifact 205 may serve as the seed artifact, target logical distances 210 and 230 may represent examples of logical distances, and compositional artifacts 215, 220, 225, 235, 240, 245, and 250 may serve as destination artifacts. In embodiments, logical distances may be calculated using tolerance parameters, such as tolerance parameter(s) 170 of FIG. 1.

In embodiments, compositional artifacts 205, 215, 220, 235, 240, 245, and 250 (e.g., artifacts represented as Xs) may be preexisting artifacts (e.g., expert-generated artifacts whose components, relative compositions, and performance vectors are known and used to create composition artifact model 200). In embodiments, compositional artifact 225 (e.g., the artifact represented as an O) may be a novel compositional artifact (e.g., a compositional artifact generated via the model).

In this example, a user may provide tolerance parameters that allow the model to determine a logical distance, represented by either target logical distance 210 or 230. In embodiments, the user may provide the logical distance itself as a tolerance parameter. If, for example, target logical distance 210 represents the logical distance, compositional artifacts 215, 220, and 225 may be displayed to the user as acceptable destination artifacts (e.g., artifacts lying within the particular logical distance from the seed artifact). If, for example, target logical distance 230 represents the logical distance, compositional artifacts 215, 220, 225, and 235 may be displayed to the user as acceptable destination artifacts.

In embodiments, any of the compositional artifacts lying within a particular logical distance may be excluded from the results displayed to the user if the user has specified filters that would apply to those compositional artifacts. For example, if compositional artifact 205 (e.g., the seed artifact) represents raisin oatmeal cookies, and the user has set a filter to remove all results that include raisins, then any of the compositional artifacts that include raisins may be excluded from a results display, even though they lie within the relevant logical distance. For example, if the relevant logical distance is represented by target logical distance 210, and compositional artifact 220 contains raisins, but compositional artifacts 215 and 225 do not contain raisins, then the results display may include compositional artifacts 215 and 225, but may exclude compositional artifact 220.

In embodiments, the compositional model 200 may be used to generate novel compositional artifacts, such as compositional artifact 225. Compositional artifact 225 may include a novel formula (e.g., a formula that was not used to create the model) that encompasses a set of components that would, given a particular relative composition, have a set of logical coordinates within the relevant logical distance from the seed artifact.

In embodiments, components within the set of components may be excluded entirely (e.g., excluded but not replaced), retained (e.g., remain identical between the seed artifact and destination artifact(s)), replaced (e.g., excluded but replaced with another ingredient/component), replaced with a plurality of components (e.g., excluded but one component with two or more components), etc. This manipulation of components may, in embodiments, be used to assemble similar flavor profiles within different classes or types of foods. For example, a user may specify that they want to maintain the flavor profile of miso soup, and embody that in a potato chip. The composition model may identify the components needed to render a potato chip (e.g., thinly-sliced potatoes, oil, etc.) and the components that may be used to provide or mimic a miso soup flavor without ruining the potato chip texture, and generate a textual compositional artifact (e.g., a formula) for making a miso soup-flavored potato chip. In embodiments, the manipulation of components may be used to stay within the same class of food, and improve the seed artifact in some way. For example, it may be used to formulate a novel formula (e.g., a recipe) for miso soup with improved flavor, cheaper cost of ingredients, etc.

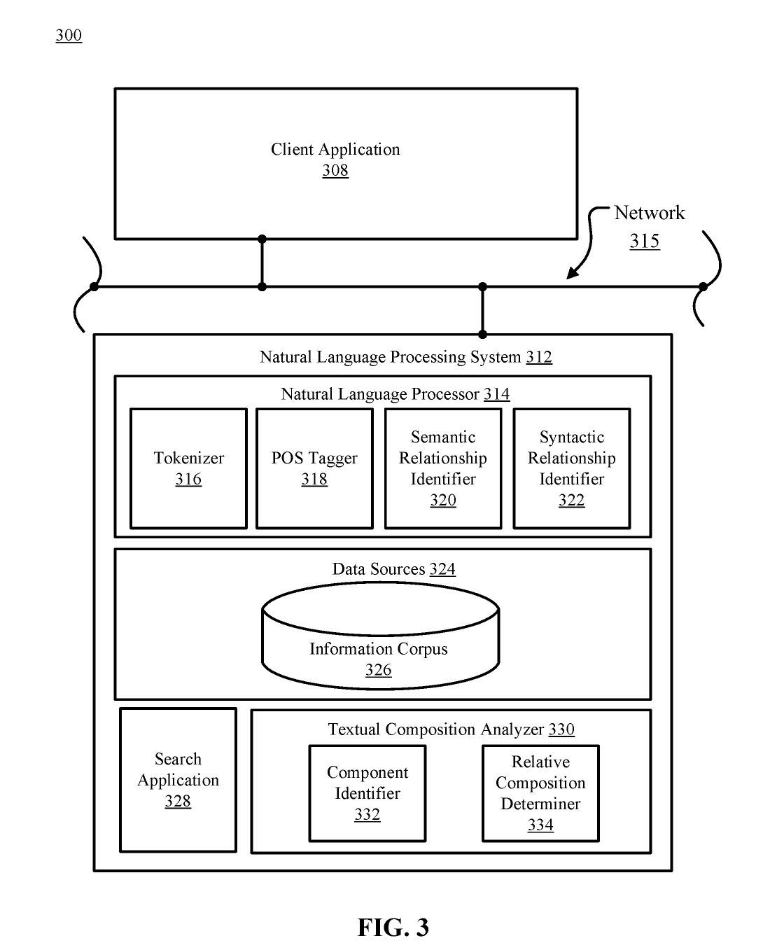

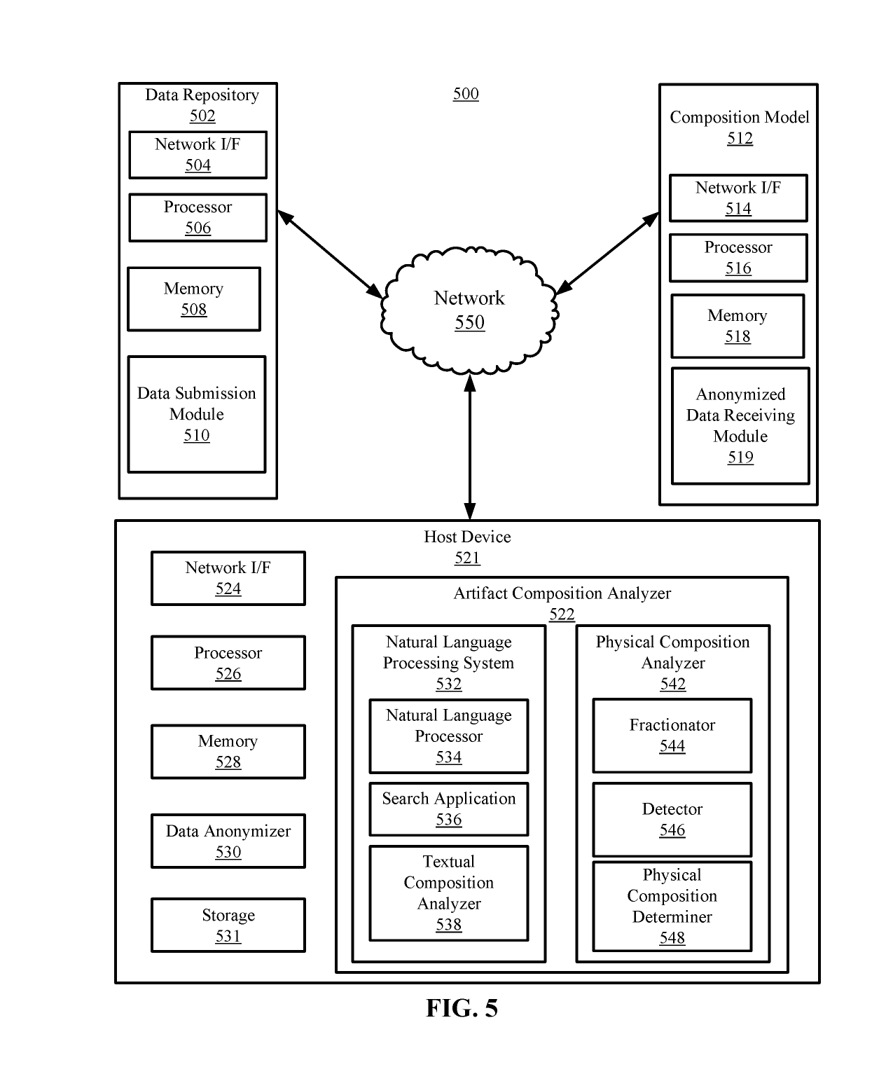

Turning now to FIG. 3, illustrated is a block diagram of an example natural language processing system configured to analyze textual compositional artifacts (e.g., text-based recipes for flavor profiles and/or food), in accordance with embodiments of the present disclosure. In some embodiments, a data repository (such as the data repository 502 of FIG. 5) may submit electronic documents (e.g., electronic textual compositional artifacts) to be analyzed to the natural language processing system 312 which may be a standalone device, or part of a larger computer system. Such a natural language processing system 312 may include a client application 308, which may itself involve one or more entities operable to generate or modify information in the unstructured textual document(s) (e.g., analog or electronic textual compositional artifacts) that is then dispatched to a natural language processing system 312 via a network 315.

Consistent with various embodiments, the natural language processing system 312 may respond to electronic document submissions sent by a client application 308. Specifically, the natural language processing system 312 may analyze a received unstructured textual document to identify a set of components and their relative compositions (e.g., the ingredients and their relative compositions). In some embodiments, the natural language processing system 312 may include a natural language processor 314, data sources 324, a search application 328, and a textual composition analyzer 330. The natural language processor 314 may be a computer module that analyzes the received unstructured textual formulae and other electronic documents. The natural language processor 314 may perform various methods and techniques for analyzing electronic documents (e.g., syntactic analysis, semantic analysis, etc.). The natural language processor 314 may be configured to recognize and analyze any number of natural languages. In some embodiments, the natural language processor 314 may parse passages of the documents. Further, the natural language processor 314 may include various modules to perform analyses of electronic documents. These modules may include, but are not limited to, a tokenizer 316, a part-of-speech (POS) tagger 318, a semantic relationship identifier 320, and a syntactic relationship identifier 322.

In some embodiments, the tokenizer 316 may be a computer module that performs lexical analysis. The tokenizer 316 may convert a sequence of characters into a sequence of tokens. A token may be a string of characters included in an electronic document and categorized as a meaningful symbol. Further, in some embodiments, the tokenizer 316 may identify word boundaries in an electronic document and break any text passages within the document into their component text elements, such as words, multiword tokens, numbers, and punctuation marks. In some embodiments, the tokenizer 316 may receive a string of characters, identify the lexemes in the string, and categorize them into tokens.

Consistent with various embodiments, the POS tagger 318 may be a computer module that marks up a word in passages to correspond to a particular part of speech. The POS tagger 318 may read a passage or other text in natural language and assign a part of speech to each word or other token. The POS tagger 318 may determine the part of speech to which a word (or other text element) corresponds, based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one formula may shed light on the meaning of text elements in another formula). In embodiments, the output of the natural language processing system 312 may populate a text index, a triplestore, or a relational database to enhance the contextual interpretation of a word or term. Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In some embodiments, the POS tagger 318 may tag or otherwise annotate tokens of a passage with part of speech categories. In some embodiments, the POS tagger 318 may tag tokens or words of a passage to be parsed by the natural language processing system 312.

In some embodiments, the semantic relationship identifier 320 may be a computer module that may be configured to identify semantic relationships of recognized text elements (e.g., words, phrases) in documents. In some embodiments, the semantic relationship identifier 320 may determine functional dependencies between entities and other semantic relationships.

Consistent with various embodiments, the syntactic relationship identifier 322 may be a computer module that may be configured to identify syntactic relationships in a passage composed of tokens. The syntactic relationship identifier 322 may determine the grammatical structure of sentences such as, for example, which groups of words are associated as phrases and which word is the subject or object of a verb. The syntactic relationship identifier 322 may conform to formal grammar.

In some embodiments, the natural language processor 314 may be a computer module that may parse a document and generate corresponding data structures for one or more portions of the document. For example, in response to receiving an unstructured textual report at the natural language processing system 312, the natural language processor 314 may output parsed text elements from the report as data structures. In some embodiments, a parsed text element may be represented in the form of a parse tree or other graph structure. To generate the parsed text element, the natural language processor 314 may trigger computer modules 316-322.

In some embodiments, the output of natural language processor 314 may be used by search application 328 to perform a search of a set of (i.e., one or more) corpora to retrieve information regarding one or more formulae or components. As used herein, a corpus may refer to one or more data sources, such as the data repository 502 of FIG. 5. In some embodiments, the data sources 324 may include data warehouses, information corpora, data models, and document repositories. In some embodiments, the data sources 324 may include an information corpus 326. The information corpus 326 may enable data storage and retrieval. In some embodiments, the information corpus 326 may be a storage mechanism that houses a standardized, consistent, clean, and integrated list of features. The information corpus 326 may also store, for each feature, a list of associated outcomes. For example, the information corpus 326 may include the chemical compositions of various ingredients or foods. The data may be sourced from various operational systems. Data stored in the information corpus 326 may be structured in a way to specifically address reporting and analytic requirements. In some embodiments, the information corpus 326 may be a data repository, a relational database, triplestore, or text index.

In some embodiments, the textual composition analyzer 330 may be a computer module that identifies a set of components and their relative composition in a compositional artifact. In some embodiments, the textual composition analyzer 330 may include a component identifier 332 and a relative composition determiner 334. When an unstructured textual document is received by the natural language processing system 312, the textual composition analyzer 330 may be configured to analyze the document using natural language processing to identify one or more components. The textual composition analyzer 330 may first parse the formula using the natural language processor 314 and related subcomponents 316-322. After parsing the formula, the component identifier 332 may identify one or more components present in the formula. This may be done, for example, by searching a dictionary (e.g., information corpus 326) using the search application 328.

The relative composition determiner 334 may determine the relative composition of the set of components identified in a formula. This may be done by using the search application 328 to traverse the various data sources (e.g., the information corpus 326) for information regarding a formula's finished product (e.g., a compositional artifact). In some embodiments, the relative composition may be estimated based on the set of components and any chemical reactions that may have occurred during preparation of the compositional artifact (e.g., Maillard reaction, roasting reactions, etc.). The relative composition determiner 334 may search, using natural language processing, documents from the various data sources for terms in the formula. In embodiments, relative composition may include a percentage for each component in the set of components (e.g., based on weight, molar ratio, volume, etc.).

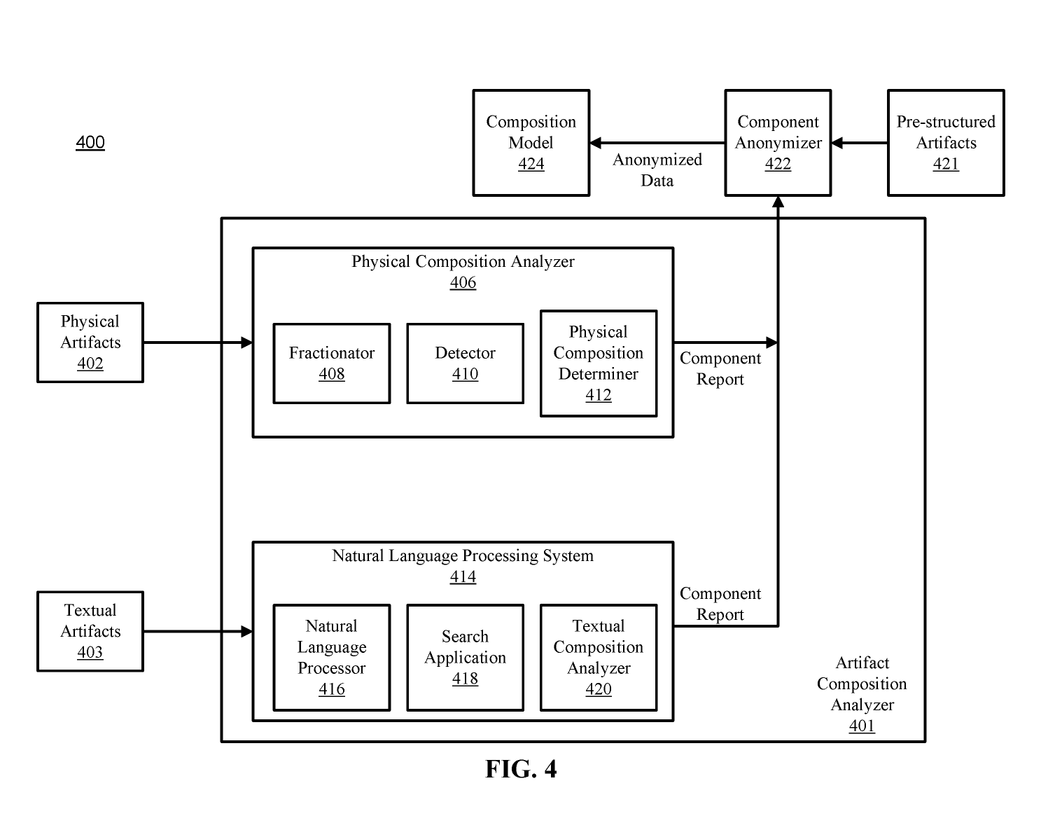

Referring now to FIG. 4, shown is a block diagram of an example high level architecture of a system 400 for determining artifact compositions, in accordance with embodiments of the present disclosure. In embodiments, the artifact composition analyzer 401 and the component anonymizer 422 may include the same characteristics as the artifact composition analyzer 120 and component anonymizer 140 of FIG. 1, respectively. Physical artifacts 402 (e.g., physical samples of foods/recipes) and textual artifacts 403 (e.g., textual formulae) may be substantially similar to seed artifact 110 described in FIG. 1.

In some embodiments, the natural language processing system 414 may include the same modules and components as the natural language processing system 312 (shown in FIG. 3). The natural language processing system 414 may include, e.g., a natural language processor 416, a search application 418, and a textual composition analyzer 420. The natural language processing system 414 may be configured to analyze the textual reports/data to identify one or more components. The natural language processing system 414 may transmit a component report to component anonymizer 422. Textual composition analyzer 420 may be substantially similar to textual composition analyzer 330 of FIG. 3.

In some embodiments, physical composition analyzer 406 may include, e.g., a fractionator 408, a detector 410, and a physical composition determiner 412. In embodiments, fractionator 408 may be substantially similar to a gas chromatographer or other chemical separator capable of breaking down an artifact into its component parts. For example, a gas chromatographer may separate chemical compounds from a homogeneous mixture.

In embodiments, detector 410 may be substantially similar to a mass spectrometer or other chemical analyzer capable of detecting an artifacts component parts and producing an artifact fingerprint (e.g., a chart/graph/readout/XML file/vector unique to a particular artifact). For example, when presented with the separated chemical compounds from a gas chromatographer, a mass spectrometer may break apart the chemical compounds into smaller ionized particles and then sort these ions based on their mass-to-charge ratio. The mass spectrometer may identify these ionized particles and produce a graph whose peaks correspond to the various ionized particles (e.g., an artifact fingerprint). Because the detection occurs at the particle level, even artifacts with minor differences in chemical composition may be identified and distinguished using mass spectrometry and gas chromatography techniques.

In embodiments, physical composition determiner 412 may include a database for storing artifact fingerprints and a comparator for comparing those artifact fingerprints. In embodiments, artifact fingerprints generated by a detector 410 may be compared to known artifact fingerprints at physical composition determiner 412 to determine a set of components for a particular artifact, as well as the relative composition of those components. Physical composition determiner 412 may generate a component report to send to component anonymizer 422.

In embodiments, pre-structured artifacts 421 may include component reports retrieved from other sources, such as a database of artifacts, their components, and relative compositions. Pre-structured artifacts 421 may be retrieved from third party sources, open sources, etc. Pre-structured artifacts 421 may include component lists at various tiers of artifact composition, as described herein. Pre-structured artifacts 421 may be stored in a database or table, and may be incorporated into a relational database, triplestore, or text index.

In embodiments, as discussed herein, component anonymizer 422 may be used to de-identify the components listed in a component report. For example, salt may be assigned a random identifier. Random identifiers may comprise letters, numbers, and/or symbols. Random identifiers may be arrays of numbers, hashes, etc. Anonymization may be recorded in a key table, or it may be performed in a standardized manner using algorithms, much like encryption techniques.

Anonymized data from component anonymizer 422 may be used in the generation and utilization of composition model 424. Composition model 424 may be substantially similar to compositional artifact model 160 of FIG. 1. In embodiments, composition model 424 may employ a neural network to perform modeling functions and generate novel artifacts, as described herein. In embodiments, a neural network may be a multi-layer perceptron, a system of sigmoid neurons, a directed acyclic graph comprising a plurality of corelets, or any other structure/system capable of neural networking.

In embodiments, composition model 424 may be used to generate a spatial model of artifacts, receive tolerance parameters and calculate logical distances between artifacts, generate novel artifacts, etc.

In embodiments, as discussed herein, a user may desire to sort a list of compositional artifacts by price. In embodiments, composition model 424 may query market prices for components of compositional artifacts in real time, and use that market data to calculate prices/value/worth of compositional artifacts on-the-fly.

Referring now to FIG. 5, illustrated is a block diagram of an example computing environment for generating composition models to generate compositional artifacts based on seed artifacts, in accordance with embodiments of the present disclosure.

Consistent with various embodiments, the host device 521, the data repository 502, and the composition model 512 may include, or be, computer systems. The host device 521, the data repository 502, and the composition model 512 may include one or more processors 526, 506, and 516 and one or more memories 528, 508, and 518, respectively. The host device 521, the data repository 502, and the composition model 512 may be configured to communicate with each other through an internal or external network interface 524, 504, and 514. The network interfaces 524, 504, and 514 may be, e.g., modems or network interface cards. The host device 521, the data repository 502, and the composition model 512 may be equipped with a display or monitor (not pictured). Additionally, the host device 521, the data repository 502, and the composition model 512 may include optional input devices (e.g., a keyboard, mouse, scanner, or other input device), and/or any commercially available or custom software (e.g., browser software, communications software, server software, speech recognition software, natural language processing software, search engine and/or web crawling software, filter modules for filtering content based upon predefined parameters, etc.). In some embodiments, the host device 521, the data repository 502, and the composition model 512 may include or be servers, desktops, laptops, or hand-held devices.

The host device 521, the data repository 502, and the composition model 512 may be distant from each other and communicate over a network 550. In some embodiments, the host device 521, the data repository 502, and the composition model 512 can establish a communication connection, such as in a client-server networking model. Alternatively, the host device 521, the data repository 502, and the composition model 512 may be configured in any other suitable networking relationship (e.g., in a peer-to-peer configuration or using any other network topology).

In embodiments, data repository 502 may be a database or other repository housing compositional artifacts or their analogs (e.g., a database of formulae). Data repository 502 may submit data, using data submission module 510, via network 550 to host device 521. Host device 521 may then identify the compositional artifact's components and relative composition and pass that information to composition model 512.

In some embodiments, the composition model 512 may enable users to submit (or may submit automatically with or without user input) electronic data (e.g., component reports, formulae, market data, etc.) to the host device 521 in order to supplement artifact composition analysis for composition model 512. In response, composition model 512 may receive the anonymized version of that electronic data. For example, the composition model 512 may include anonymized data receiving module 520 and a user interface (UI). The UI may be any type of interface (e.g., command line prompts, menu screens, graphical user interfaces). The UI may allow a user to interact with the host device 521 to submit electronic data to the host device 521.

In embodiments, the host device 521 may include an artifact composition analyzer 522. Artifact composition analyzer 522 may be substantially similar to component analyzer 120 of FIG. 1, textual composition analyzer 330 of FIG. 3, or artifact composition analyzer 401 of FIG. 4.

In some embodiments, the artifact composition analyzer 522 may include a natural language processing system 532, which may be substantially similar to natural language processing system 312 of FIG. 3 or natural language processing system 414 of FIG. 4. The natural language processing system 532 may include a natural language processor 534, a search application 536, and a report analysis module 538. The natural language processor 534 may include numerous subcomponents, such as a tokenizer, a part-of-speech (POS) tagger, a semantic relationship identifier, and a syntactic relationship identifier.

The search application 536 may be implemented using a conventional or other search engine, and may be distributed across multiple computer systems. The search application 536 may be configured to search one or more databases, as described herein, or other computer systems for content that is related to an electronic document (such as a recipe or other formula) submitted by, or retrieved from, a data repository 502. For example, the search application 536 may be configured to search dictionaries, papers, and/or archived compositional artifacts (e.g., formulae) to help identify one or more artifacts or components, in the received compositional artifact(s). The textual composition analyzer 538 may be configured to analyze a textual compositional artifact to identify a set of components (e.g., ingredients) and their relative composition (e.g., for each component, the percentage of the compositional artifact that is composed of that component). The textual composition analyzer 538 may include one or more modules or units, and may utilize the search application 536 to perform its functions (e.g., to identify one or more components and their relative composition), as discussed in more detail in reference to FIGS. 1, 3, and 4.

In some embodiments, the artifact composition analyzer 522 may include a physical composition analyzer 542. The physical composition analyzer 542 may be substantially similar to the physical composition analyzer 406 of FIG. 4. The physical composition analyzer 542 may utilize one or more models, modules, or units to perform its functions (e.g., to analyze a physical sample of a compositional artifact and identify its components and their relative composition). For example, the physical composition analyzer 542 may include one or more physical compositional artifact processing modules (e.g., a mass spectrometer, gas chromatographer, gas chromatograph flame ionization detector, or other chemical analyzer) that are configured to identify the chemical compounds in a compositional artifact sample. The physical composition analyzer modules may include a fractionator 544 to break down an artifact into its component parts. As another example, the physical composition analyzer 542 may include a detector 546 to identify a set of components of a compositional artifact or to create an artifact fingerprint, as described herein. In embodiments, physical composition analyzer 542 may further include a physical composition determiner 548. Physical composition determiner 548 may analyze the output of detector 546 to determine the relative composition of the set of components of a compositional artifact. In some embodiments, the physical composition analyzer modules may be, at least in part, implemented as software modules. In some embodiments, fractionator 544 and detector 546 may be combined, as much as possible, into a single module or divided among the several components of the host device 521 or the artifact composition analyzer 522.

In some embodiments, the host device 521 may include a data anonymizer 530. The data anonymizer 530 may be configured to receive component reports from the natural language processing system 532 and the physical composition analyzer 542 or from the structured data input and anonymize the components listed, as described herein.

In some embodiments, the natural language processing system 532 may have an optical character recognition (OCR) module (not pictured). The OCR module may be configured to receive an analog format of an unstructured textual artifact sent from a data repository 502 and perform optical character recognition (or a related process) on the artifact to convert it into machine-encoded text so that the natural language processor 534 may perform NLP on the artifact. For example, the data repository 502 may transmit an image of a scanned formula to the host device. The OCR module may convert the image into machine-encoded text, and then the converted report may be sent to the natural language processor 534 for analysis. In some embodiments, the OCR module may be a subcomponent of the natural language processor 534. In other embodiments, the OCR module may be a standalone module within the host device 521 or artifact composition analyzer 522. In still other embodiments, the OCR module may be located within the data repository 502 and may perform OCR on the unstructured, analog, textual compositional artifacts before they are sent to the host device 521 or the artifact composition analyzer 522.

Host device 521 may further include storage 531 for storing compositional artifacts, component reports, artifact fingerprints, anonymized data, etc. In embodiments, a composition model may be loaded into active memory (e.g., memory 528 or memory 518) to process real-time input (e.g., market data regarding the prices of components) when determining tolerance parameters, calculating logical distances, generating novel compositional artifacts, or otherwise utilizing the composition model.

While FIG. 5 illustrates a computing environment 500 with a single host device 521, a single data repository 502, and a single composition model 512, suitable computing environments for implementing embodiments of this disclosure may include any number of host devices, data repositories, and composition models. The various models, modules, systems, and components discussed in relation to FIG. 5 may exist, if at all, across a plurality of host devices, data repositories, and composition models. For example, some embodiments may include two host devices and multiple data repositories. The two host devices may be communicatively coupled using any suitable communications connection (e.g., using a WAN, a LAN, a wired connection, an intranet, or the Internet). The first host device may include a natural language processing system configured to receive and analyze textual compositional artifacts, and the second host device may include a physical composition analyzer configured to receive and analyze physical samples of compositional artifacts.

It is noted that FIG. 5 is intended to depict the representative major components of an exemplary computing environment 500. In some embodiments, however, individual components may have greater or lesser complexity than as represented in FIG. 5, components other than or in addition to those shown in FIG. 5 may be present, and the number, type, and configuration of such components may vary.

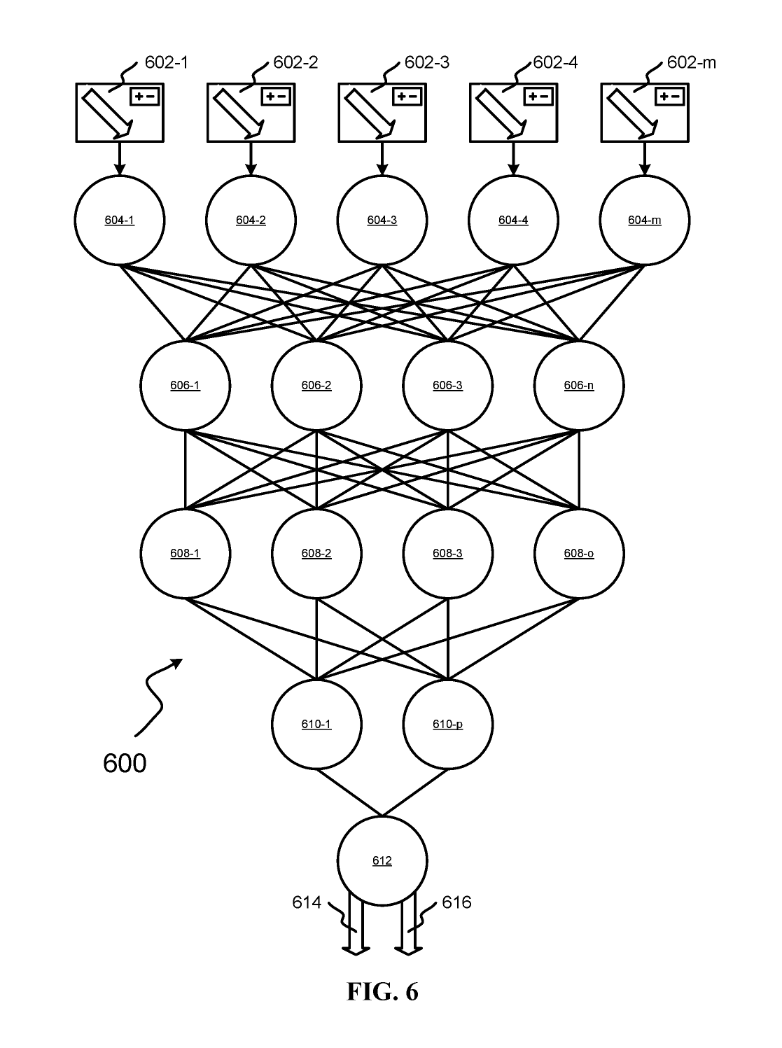

FIG. 6 depicts an example neural network 600 that may be specialized to process a set of components and/or relative compositions associated with a compositional artifact. The neural network 600 may also be specialized to generate compositional artifacts as output, based on a seed artifact and/or a set of components and their relative compositions. In embodiments, neural network 600 may be a classifier-type neural network. Neural network 600 may be part of a larger neural network. For example, neural network 600 may be nested within a single, larger neural network, connected to several other neural networks, or connected to several other neural networks as part of an overall aggregate neural network.

Inputs 602-1 through 602-m represent the inputs to neural network 600. In this embodiment, 602-1 through 602-m do not represent different inputs. Rather, 602-1 through 602-m represent the same input that is sent to each first-layer neuron (neurons 604-1 through 604-m) in neural network 600. In some embodiments, the number of inputs 602-1 through 602-m (i.e., the number represented by m) may equal (and thus be determined by) the number of first-layer neurons in the network. In other embodiments, neural network 600 may incorporate 1 or more bias neurons in the first layer, in which case the number of inputs 602-1 through 602-m may equal the number of first-layer neurons in the network minus the number of first-layer bias neurons. In some embodiments, a single input (e.g., input 602-1) may be input into the neural network. In such an embodiment, the first layer of the neural network may comprise a single neuron, which may propagate the input to the second layer of neurons.

Inputs 602-1 through 602-m may comprise one or more artifact component(s) and a relative composition that is associated with a compositional artifact. For example, inputs 602-1 through 602-m may comprise 10 components with their relative compositions that are associated with a seed artifact. In other embodiments, not all components and their relative compositions may be input into neural network 600. For example, in some embodiments, 30 components may be input into neural network 600, but relative compositions for only 20 components may be input into neural network 600.

Neural network 600 may comprise 5 layers of neurons (referred to as layers 604, 606, 608, 610, and 612, respectively corresponding to illustrated nodes 604-1 to 604-m, nodes 606-1 to 606-n, nodes 608-1 to 608-o, nodes 610-1 to 610-p, and node 612). In some embodiments, neural network 600 may have more than 5 layers or fewer than 5 layers. These 5 layers may each be comprised of the same number of neurons as any other layer, more neurons than any other layer, fewer neurons than any other layer, or more neurons than some layers and fewer neurons than other layers. In this embodiment, layer 612 is treated as the output layer. Layer 612 outputs a probability that a target event will occur, and contains only one neuron (neuron 612). In other embodiments, layer 612 may contain more than 1 neuron. In this illustration no bias neurons are shown in neural network 600. However, in some embodiments each layer in neural network 600 may contain one or more bias neurons.

Layers 604-612 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the ReLU function. For example, layer 604 may be a “dropout” layer, which may process the input of the previous layer (here, the inputs) with some neurons removed from processing. This may help to average the data, and can prevent overspecialization of a neural network to one set of data or several sets of similar data. Dropout layers may also help to prepare the data for “dense” layers. Layer 606, for example, may be a dense layer. In this example, the dense layer may process and reduce the dimensions of the feature vector (e.g., the vector portion of inputs 602-1 through 602-m) to eliminate data that is not contributing to the prediction. As a further example, layer 608 may be a “batch normalization” layer. Batch normalization may be used to normalize the outputs of the batch-normalization layer to accelerate learning in the neural network. Layer 610 may be any of a dropout, hidden, or batch-normalization layer. Note that these layers are examples. In other embodiments, any of layers 604 through 610 may be any of dropout, hidden, or batch-normalization layers. This is also true in embodiments with more layers than are illustrated here, or fewer layers.

Layer 612 is the output layer. In this embodiment, neuron 612 produces outputs 614 and 616. Outputs 614 and 616 represent complementary probabilities that a target event will or will not occur. For example, output 614 may represent the probability that a target event will occur, and output 616 may represent the probability that a target event will not occur. In some embodiments, outputs 614 and 616 may each be between 0.0 and 1.0, and may add up to 1.0. In such embodiments, a probability of 1.0 may represent a projected absolute certainty (e.g., if output 614 were 1.0, the projected chance that the target event would occur would be 100%, whereas if output 616 were 1.0, the projected chance that the target event would not occur would be 100%).

FIG. 6 illustrates an example probability-generator neural network with one pattern-recognizer pathway (i.e., a pathway of neurons that processes one set of inputs and analyzes those inputs based on recognized patterns, and produces one set of outputs. However, some embodiments may incorporate a probability-generator neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant. In embodiments, neural network 600 may be trained (e.g., biases and weights among nodes may be calibrated) by inputting the sets of components and the relative compositions of a plurality of known compositional artifacts, receiving an output from the neural network, and inputting corrections into the neural network to arrive at an expected output.

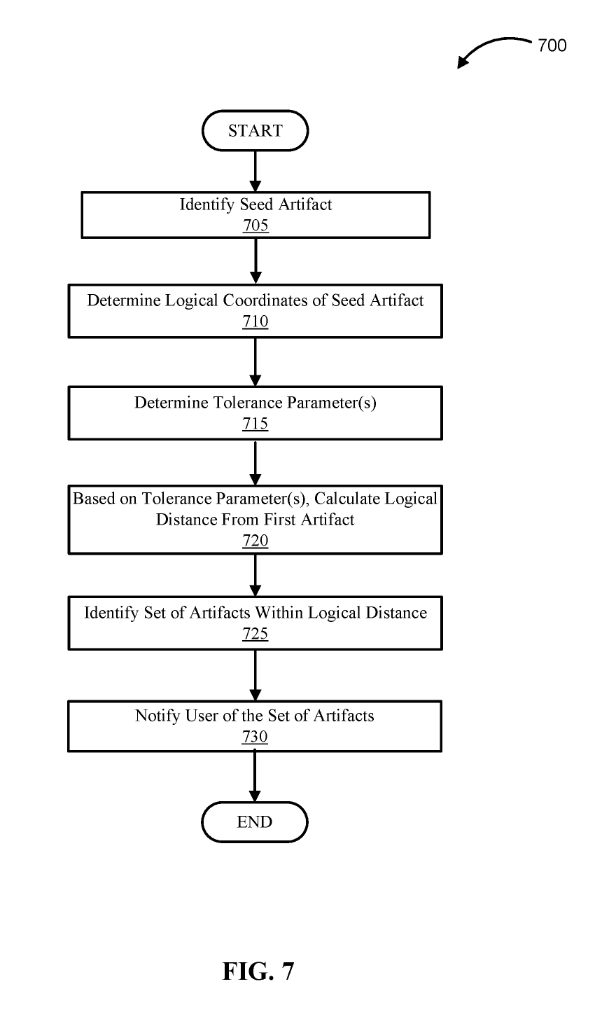

Referring now to FIG. 7, illustrated is a flowchart of a method 700 for using a composition model to identify compositional artifacts based on seed artifacts, in accordance with embodiments of the present disclosure. At 705, a seed artifact may be identified. A seed artifact may be a compositional artifact whose logical coordinates will be used as the definition for a logical distance of zero. For example, a seed artifact may be miso soup, and the logical coordinates of miso soup would serve as zero for a calculation of logical distance (e.g., miso soup will be the artifact at the center of a target logical distance, as described in reference to FIG. 2).

At 710, the logical coordinates of a seed artifact may be determined. As described herein, a determination of the logical coordinates of an artifact may be based on a set of components, and their relative composition, of an artifact. For example, the set of components, and relative composition, for miso soup may include 20% miso bean paste, 60% fish stock, 10% tofu, 5% green onions, and 5% shiitake mushrooms. In embodiments, the set of components may be further broken down into chemical compositions, as described herein. In embodiments, cascading tiers of component sets may be utilized, as described herein. In embodiments, the set of components and relative composition may be used to determine a unique logical coordinate for the artifact.

At 715, tolerance parameter(s) are determined. Tolerance parameters may include, for example, whether certain components are to be excluded or included in a destination artifact, as described herein. In embodiments, tolerance parameters may include a user's desired logical distance.

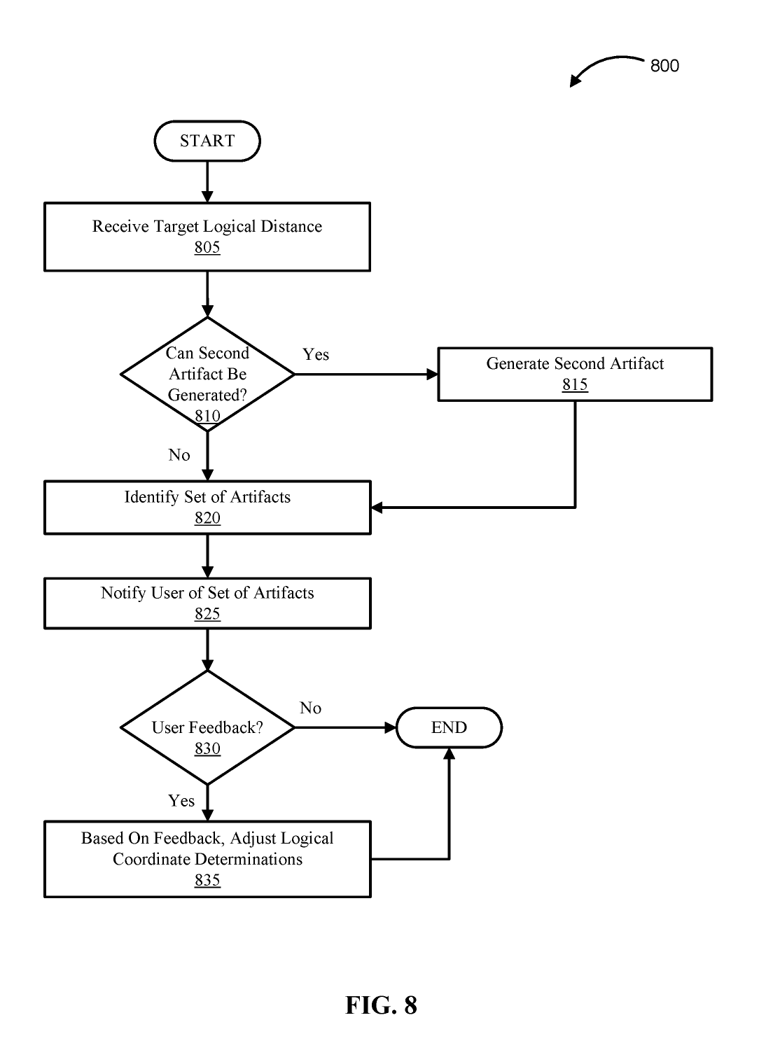

At 720, a logical distance from the seed artifact is calculated, based on the tolerance parameter(s). In embodiments, the user may outright specify the logical distance. In embodiments, logical distance calculations (e.g., Earthmover, Mahalanobis, Euclidian, etc.) from a seed artifact may take into account tolerance parameters specified by a user. For example, a user may specify that there must be at least 10 artifacts within the calculated logical distance, and that a particular component must be identical between the seed artifact and the destination artifact, or that a particular component from the seed artifact must not be present in the destination artifact, as described herein. Based on this information, a target logical distance may be calculated, where the logical distance from the seed artifact contains at least 10 artifacts whose component sets fall within the user-specified criteria. Taking another example, if the user specifies they want to see the 15 compositional artifacts nearest, logically, to miso soup that contain the same ingredients, but with the fish stock excluded (or replaced), the logical distance between miso soup (e.g., the seed artifact) and the 15^{th} nearest compositional artifact to miso soup that does not include fish stock (e.g., the 15^{th} nearest destination artifact without fish stock, or with fish stock replaced by another ingredient) may be the calculated logical distance. In embodiments, one or more novel destination artifacts may be generated within the calculated logical distance and accounted for in the logical distance calculation (described in more detail in FIG. 8). For example, a novel compositional artifact for chicken miso soup (e.g., a compositional artifact with ingredients identical to miso soup, but with chicken stock substituted for fish stock) may be generated (e.g., chicken miso soup may not be a known compositional artifact, but generated by a composition model) and lie within the specified logical distance.

The examples and illustrations given herein are for demonstrative purposes, and are not meant to limit the scope of the disclosure. Additionally, the methods contemplated herein may be used in other applications (e.g., with perfumes, fragrances, fuels, adhesives, lubricants, or other heterogeneous mixtures).

At 725, a set of artifacts within the logical distance is identified. In embodiments in which the compositional artifacts' components have been anonymized, the anonymized data may be used to look up a destination artifact in a hash table or database at 725. In embodiments, a destination artifact may be a novel compositional artifact. In such embodiments, the anonymized data may be re-identified to generate a formula for creating the novel compositional artifact.

At 730, a user is notified of the set of artifacts. In embodiments, the user may be notified, for example, via an interactive user interface by producing an information window, line of text, status alert, chart, graph, etc.

Referring now to FIG. 8, illustrated is a flowchart of a method 800 for using a composition model to generate compositional artifacts and adjust logical coordinate determinations, in accordance with embodiments of the present disclosure. In embodiments, method 800 may be implemented within, or in addition to, method 700 of FIG. 7.

At 805, a target logical distance is received. In embodiments, the target logical distance is calculated substantially similarly to the target logical distance described in FIG. 7.

At 810, it is determined whether a second artifact (e.g., a novel compositional artifact) can be generated. If, at 810, it is determined that a second artifact can be generated, the generation of the second artifact occurs at 815. Generation of a second artifact may include a determination of the set of components, their relative composition, and any preparation techniques (e.g., cooking techniques) required to produce a finished compositional artifact (e.g., a formula).

At 820, a set of artifacts is identified. In embodiments, 820 may be substantially similar to the operation of 725 in FIG. 7.

At 825, a user is notified of the set of artifacts. In embodiments, 825 may be substantially similar to the operation of 730 in FIG. 7.

At 830, it is determined whether the user has feedback. In embodiments, a user may be presented with a prompt to rate the performance of the composition model. Ratings may be employed by a 1-5 star system, a 1-10 scale, or any other ratings scheme.

If it is determined, at 830, that the user has input feedback, the feedback may be used, at 835, to adjust logical coordinate determinations of compositional artifacts. For example, if a user makes a formula from the set of artifacts that was presented to the user at 825 and rates it poorly, it may indicate that the logical distance between the seed artifact and second artifact (e.g., the artifact correlated with the formula that the user made) should be increased in the composition model. The logical coordinates of the second artifact may be adjusted to reflect this increased logical distance. Likewise, if the user rates a formula highly, the logical distance may be decreased, or if the user does not rate the formula, or gives a neutral rating, the logical distance may be left unchanged.

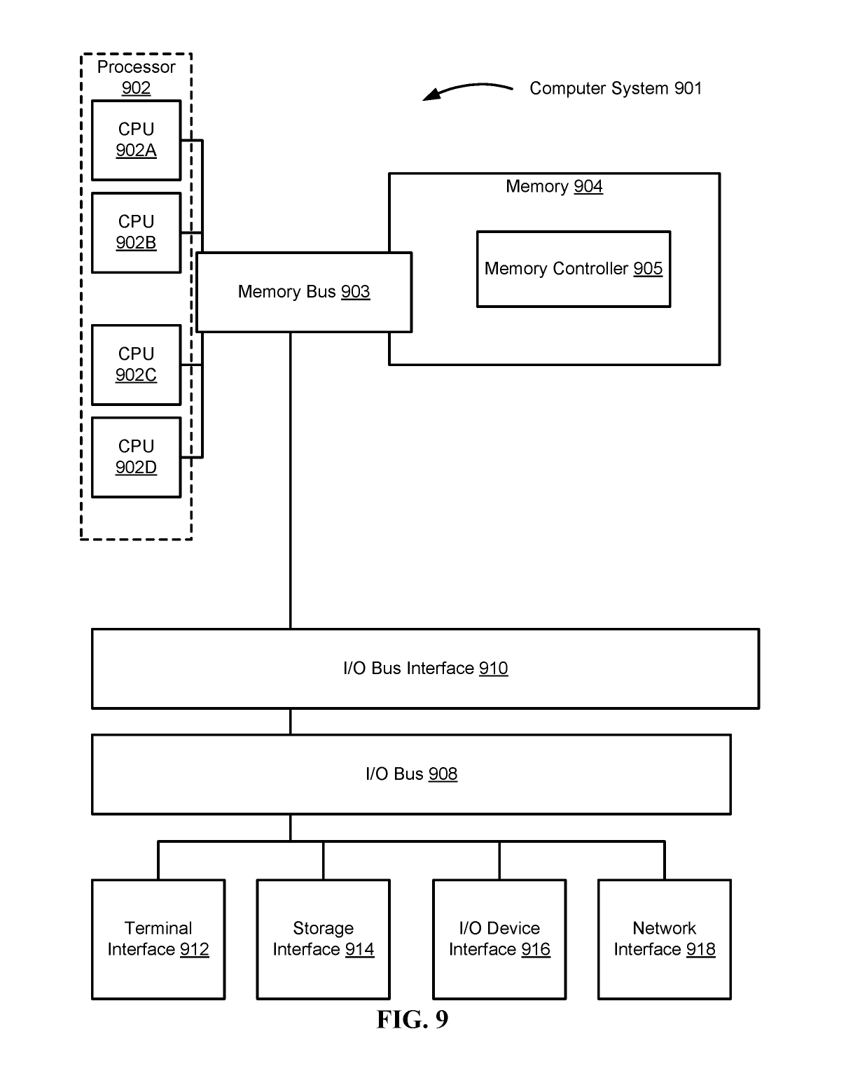

Referring now to FIG. 9, shown is a high-level block diagram of an example computer system (e.g., computer) 901 that may be configured to perform various aspects of the present disclosure, including, for example, methods 700 and 800, described in FIGS. 7 and 8, respectively. The example computer system 901 may be used in implementing one or more of the methods or modules, and any related functions or operations, described herein (e.g., using one or more processor circuits or computer processors of the computer), in accordance with embodiments of the present disclosure. In some embodiments, the major components of the computer system 901 may comprise one or more CPUs 902, a memory subsystem 904, a terminal interface 912, a storage interface 914, an I/O (Input/Output) device interface 916, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable central processing units (CPUs) 902A, 902B, 902C, and 902D, herein generically referred to as the CPU 902. In some embodiments, the computer system 901 may contain multiple processors typical of a relatively large system; however, in other embodiments the computer system 901 may alternatively be a single CPU system. Each CPU 902 may execute instructions stored in the memory subsystem 904 and may comprise one or more levels of on-board cache.

In some embodiments, the memory subsystem 904 may comprise a random-access semiconductor memory, storage device, or storage medium (either volatile or non-volatile) for storing data and programs. In some embodiments, the memory subsystem 904 may represent the entire virtual memory of the computer system 901, and may also include the virtual memory of other computer systems coupled to the computer system 901 or connected via a network. The memory subsystem 904 may be conceptually a single monolithic entity, but, in some embodiments, the memory subsystem 904 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 904 may contain elements for control and flow of memory used by the CPU 902. This may include a memory controller 905.

Although the memory bus 903 is shown in FIG. 9 as a single bus structure providing a direct communication path among the CPUs 902, the memory subsystem 904, and the I/O bus interface 910, the memory bus 903 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units are shown, which separate the I/O bus 908 from various communications paths running to the various I/O devices, in other embodiments some or all of the I/O devices may be connected directly to one or more system I/O buses.

In some embodiments, the computer system 901 may be a multi-user mainframe computer system, a single-user system, or a server computer or similar device that has little or no direct user interface, but receives requests from other computer systems (clients). Further, in some embodiments, the computer system 901 may be implemented as a desktop computer, portable computer, laptop or notebook computer, tablet computer, pocket computer, telephone, smart phone, mobile device, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for using a composition model to generate compositional artifacts, the method comprising:
identifying a first artifact;
determining a first set of logical coordinates within the compositional artifact model for the first artifact;
identifying a tolerance parameter;
calculating, based on the first set of logical coordinates and the tolerance parameter, a logical distance from the first artifact;
identifying a second artifact, the second artifact having a second set of logical coordinates within the logical distance from the first set of logical coordinates of the first artifact; and
notifying a user of the second artifact.

2. The method of claim 1, wherein the composition model is generated by a method comprising:
receiving a plurality of artifacts;
identifying a first artifact among the plurality of artifacts and a second artifact among the plurality of artifacts;
identifying a first set of components for the first artifact of the plurality of artifacts and a second set of components for the second artifact of the plurality of artifacts;
determining a first relative composition of the first set of components of the first artifact and a second relative composition of the second set of components of the second artifact; and
determining a first set of logical coordinates for the first artifact based on the first set of components and the first relative composition, and a second set of logical coordinates for the second artifact based the second set of components and the second relative composition.

3. The method of claim 1, further comprising:
identifying a set of components for the first artifact;
determining a relative composition of the set of components for the first artifact; and
determining the first set of logical coordinates for the first artifact, based on the set of components and the relative composition of the set of components for the first artifact.

4. The method of claim 2, further comprising:
training a neural network to generate a third artifact by inputting the sets of components and the relative compositions of the plurality of artifacts;
receiving a suggested third artifact from the neural network;
correcting the set of components for the third artifact; and
inputting the correction into the neural network.

5. The method of claim 4, further comprising:
inputting the first set of components and the relative composition of the first set of components into a neural network; and
generating, based on the first set of components and the relative composition of the first set of components, a third artifact.

6. The method of claim 3, further comprising:
identifying a set of components for the second artifact;
determining a relative composition of the set of components for the second artifact; and
determining the second set of logical coordinates for the second artifact, based on the set of components and the relative composition of the set of components for the second artifact.

7. The method of claim 5, wherein a third set of logical coordinates for the third artifact is determined, the third set of logical coordinates being within the logical distance of the first artifact.

8. A system for using a composition model to generate compositional artifacts, the system comprising:
a memory; and
a processor in communication with the memory, wherein the computer system is configured to perform a method, the method comprising:
identifying a first artifact;
determining a first set of logical coordinates within the compositional artifact model for the first artifact;
identifying a tolerance parameter;
calculating, based on the first set of logical coordinates and the tolerance parameter, a logical distance from the first artifact;
identifying a second artifact, the second artifact having a second set of logical coordinates within the logical distance from the first set of logical coordinates of the first artifact; and
notifying a user of the second artifact.

9. The system of claim 8, wherein the composition model is generated by a method comprising:
receiving a plurality of artifacts;
identifying a first artifact among the plurality of artifacts and a second artifact among the plurality of artifacts;
identifying a first set of components for the first artifact of the plurality of artifacts and a second set of components for the second artifact of the plurality of artifacts;
determining a first relative composition of the first set of components of the first artifact and a second relative composition of the second set of components of the second artifact; and
determining a first set of logical coordinates for the first artifact based on the first set of components and the first relative composition, and a second set of logical coordinates for the second artifact based the second set of components and the second relative composition.

10. The system of claim 8, wherein the method further comprises:
identifying a set of components for the first artifact;
determining a relative composition of the set of components for the first artifact; and
determining the first set of logical coordinates for the first artifact, based on the set of components and the relative composition of the set of components for the first artifact.

11. The system of claim 9, wherein the method further comprises:
training a neural network to generate a third artifact by inputting the sets of components and the relative compositions of the plurality of artifacts;
receiving a suggested third artifact from the neural network;
correcting the set of components for the third artifact; and
inputting the correction into the neural network.

12. The system of claim 11, wherein the method further comprises:
inputting the first set of components and the relative composition of the first set of components into a neural network; and
generating, based on the first set of components and the relative composition of the first set of components, a third artifact.

13. The system of claim 10, wherein the method further comprises:
identifying a set of components for the second artifact;
determining a relative composition of the set of components for the second artifact; and
determining the second set of logical coordinates for the second artifact, based on the set of components and the relative composition of the set of components for the second artifact.

14. The system of claim 12, wherein a third set of logical coordinates for the third artifact is determined, the third set of logical coordinates being within the logical distance of the first artifact.

15. A computer program product for using a composition model to generate compositional artifacts, the computer program product comprising a computer readable storage medium having program instructions embodied therewith, the program instructions executable by a device to cause the device to perform a method, the method comprising:
identifying a first artifact;
determining a first set of logical coordinates within the compositional artifact model for the first artifact;
identifying a tolerance parameter;
calculating, based on the first set of logical coordinates and the tolerance parameter, a logical distance from the first artifact;
identifying a second artifact, the second artifact having a second set of logical coordinates within the logical distance from the first set of logical coordinates of the first artifact; and
notifying a user of the second artifact.

16. The computer program product of claim 15, wherein the composition model is generated by a method comprising:
receiving a plurality of artifacts;
identifying a first artifact among the plurality of artifacts and a second artifact among the plurality of artifacts;
identifying a first set of components for the first artifact of the plurality of artifacts and a second set of components for the second artifact of the plurality of artifacts;
determining a first relative composition of the first set of components of the first artifact and a second relative composition of the second set of components of the second artifact; and
determining a first set of logical coordinates for the first artifact based on the first set of components and the first relative composition, and a second set of logical coordinates for the second artifact based the second set of components and the second relative composition.

17. The computer program product of claim 15, wherein the method further comprises:
identifying a set of components for the first artifact;
determining a relative composition of the set of components for the first artifact; and
determining the first set of logical coordinates for the first artifact, based on the set of components and the relative composition of the set of components for the first artifact.

18. The computer program product of claim 16, wherein the method further comprises:
training a neural network to generate a third artifact by inputting the sets of components and the relative compositions of the plurality of artifacts;
receiving a suggested third artifact from the neural network;
correcting the set of components for the third artifact; and
inputting the correction into the neural network.

19. The computer program product of claim 18, wherein the method further comprises:
inputting the first set of components and the relative composition of the first set of components into a neural network; and
generating, based on the first set of components and the relative composition of the first set of components, a third artifact.

20. The computer program product of claim 17, wherein the method further comprises:
identifying a set of components for the second artifact;
determining a relative composition of the set of components for the second artifact; and
determining the second set of logical coordinates for the second artifact, based on the set of components and the relative composition of the set of components for the second artifact.
